(19) United States
(12) Patent Application Publication
(10) Pub. No.: US 2025/0328412 A1
(43) Pub. Date: Oct. 23, 2025

(54) SYSTEM AND METHODS FOR DATA CENTER FAULT MITIGATION

(71) Applicant: MetalSoft Cloud, Inc., Chicago, IL (US)

(72) Inventors: Lucas Joon Roh, Chicago, IL (US); Alex Bordei, Dobroesti (RO)

(73) Assignee: MetalSoft Cloud, Inc., Chicago, IL (US)

(21) Appl. No.: 19/072,097

(22) Filed: Mar. 6, 2025

Related U.S. Application Data
(60) Provisional application No. 63/636,570, filed on Apr. 19, 2024.

(51) Int. Cl. G06F 11/07; G06F 8/30; G06F 40/274

(52) U.S. Cl. CPC G06F 11/0793; G06F 8/30; G06F 40/274

(57) ABSTRACT

A computer system for use with a data center includes a monitoring system configured to receive telemetry data from the data center and to generate alert data in response to a data center fault indicated by the telemetry data; a data center orchestrator coupled to the monitoring system that is configured to manage operation of the data center; and a self-healing engine that operates via an application programming interface (API) configured to receive the alert data, topology data corresponding to a topology of the data center, and user intent data and to select and execute one or more skills in conjunction with the data center orchestrator to correct the data center fault.

### CROSS-REFERENCE TO RELATED APPLICATIONS

The present U.S. Utility Patent Application claims priority pursuant to 35 U.S.C. § 119 (e) to U.S. Provisional Application No. 63/636,570, entitled “SYSTEM AND METHODS FOR AI-BASED DATA CENTER FAULT MITIGATION”, filed Apr. 19, 2024, which is hereby incorporated herein by reference in its entirety and made part of the present U.S. Utility Patent Application for all purposes.

### BACKGROUND

### Technical Field

This disclosure relates generally to data centers and computer networks with fault mitigation and methods for use therewith.

### BRIEF DESCRIPTION OF THE SEVERAL VIEWS OF THE DRAWING(S)

FIG. 1A presents a schematic block diagram representation of an example computer system;

FIG. 1B presents a flow diagram representation of an example fault mitigation;

FIG. 1C presents a schematic block diagram representation of an example of a self-healing engine;

FIG. 1D presents a screen display of data fields corresponding to an example user-defined skill;

FIGS. 1E-1H present flow diagram representations of example fault mitigation procedures;

FIG. 1I presents a flow diagram representation of an example method;

FIGS. 2A through 2E are schematic block diagrams of embodiments of computing entities that are part of an improved computer technology;

FIGS. 2F through 2L are schematic block diagrams of embodiments of computing devices that form at least a portion of a computing entity; and

FIG. 2M is a schematic block diagram of an embodiment of a database.

### DETAILED DESCRIPTION

Modern data center infrastructures composed out of servers, switches, storage appliances, firewalls, virtual machines (VM) s, containers and other similar devices which are very complex often having multiple levels of encapsulation and different overlapping control planes. Given the amount of complexity, an orchestrator solution (which can also be referred to as a data center orchestrator or more simply, an orchestrator) is often used to manage the data center including, for example, the network fabrics as well as other components such as servers and storage units, etc. Examples of such orchestrators include Canonical MaaS, RackN, Juniper Apstra, etc. These solutions deal with this complexity of the data center architecture and lower the cost of an infrastructure. Operators no longer have to rely on experts to operate the network on a daily basis.

However, if something breaks, only highly trained, specialized staff can trace issues across the many layers of network abstraction and encapsulation.

The present disclosure improves the technology of data center control and fault diagnosis/mitigation by providing artificial intelligence (AI) based and/or other computational intensive automatic troubleshooting and/or automated self-healing of these complex infrastructures, eliminating (or mitigating) the need of expert human intervention. In various examples, a self-healing engine is presented that interacts with an orchestrator and/or with human datacenter technicians via the automation solution's API. In various examples, the self-healing engine includes a hybrid reasoning model—where a combination of human expert-defined “skills” along with various computer components are used to define the troubleshooting strategy, to interpret the results at each step of the troubleshooting strategy and also determine the next diagnostic steps and/or fixes to perform. In various examples the combination of skills can include both (a) low level diagnostic “skills” that the engine can use that are commands such as “ping”, “traceroute”, information such as topology as well as accumulated monitoring data; and (b) higher level “skills” with pre-defined standard diagnosis steps. The hybrid reasoning model of the self-healing engine can employ one or more large language models (LLMs) to generate code that calls available functions given a problem defined in natural language by an operator. This can allow the system to avoid many of the limitations of LLMs with respect to hallucinations, complex reasoning especially around graph operations but still use their excellent interpretation, summarization and pattern matching capabilities. The more successful diagnostics the engine sees, the better it can be trained to use its own experience rather than relying on a subset of expert-defined fixed skills.

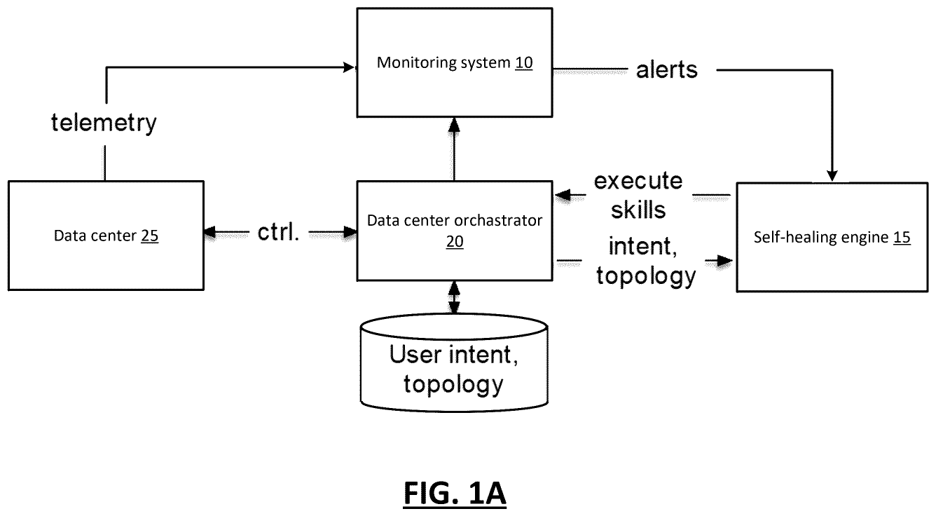

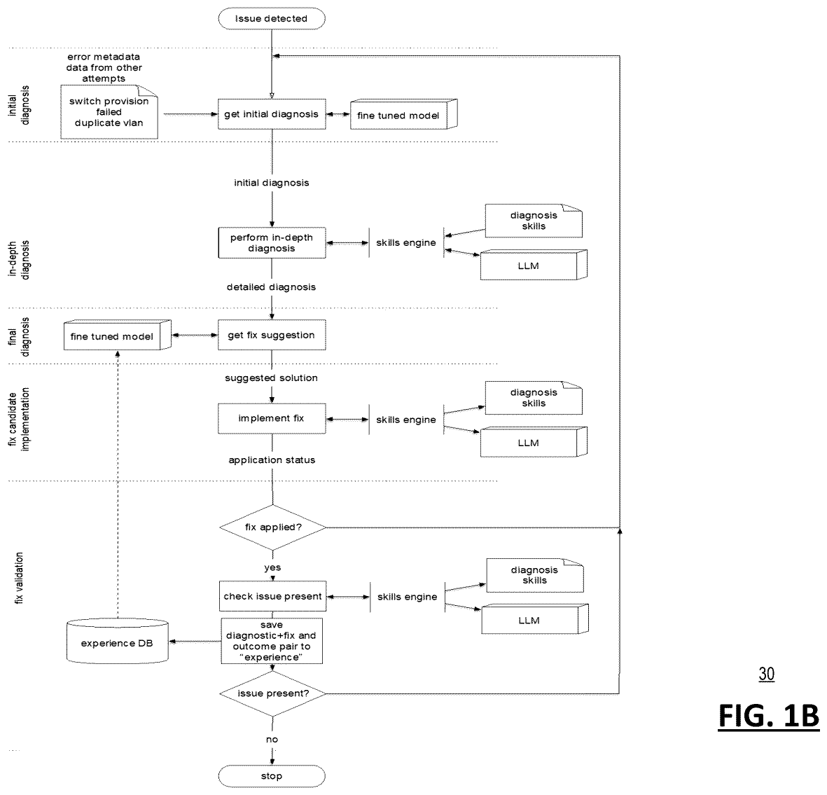

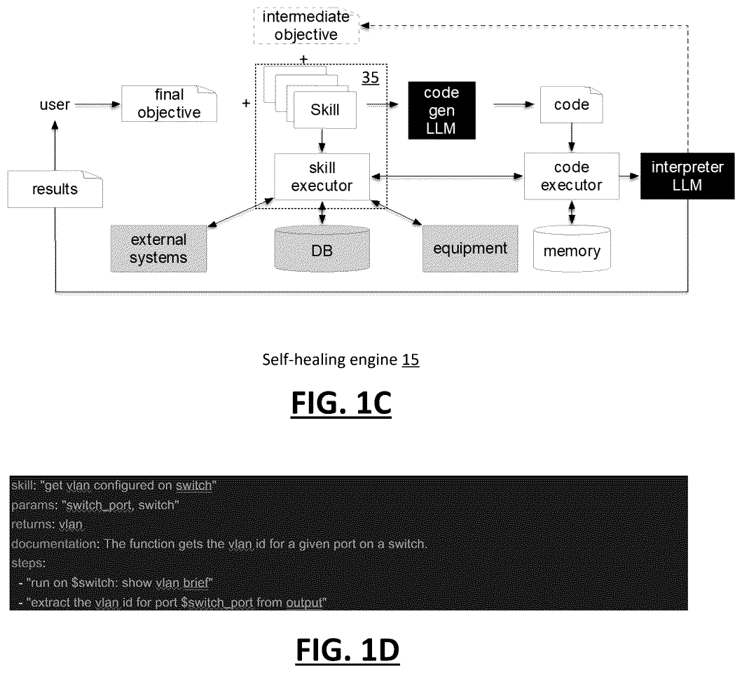

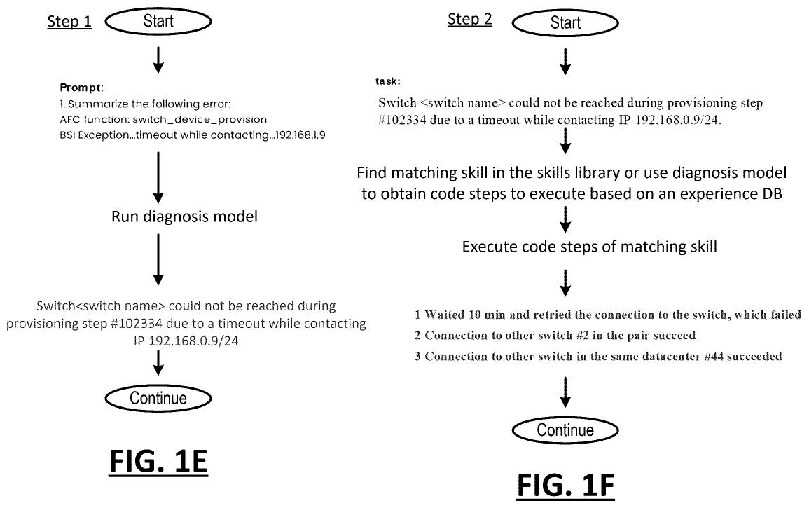

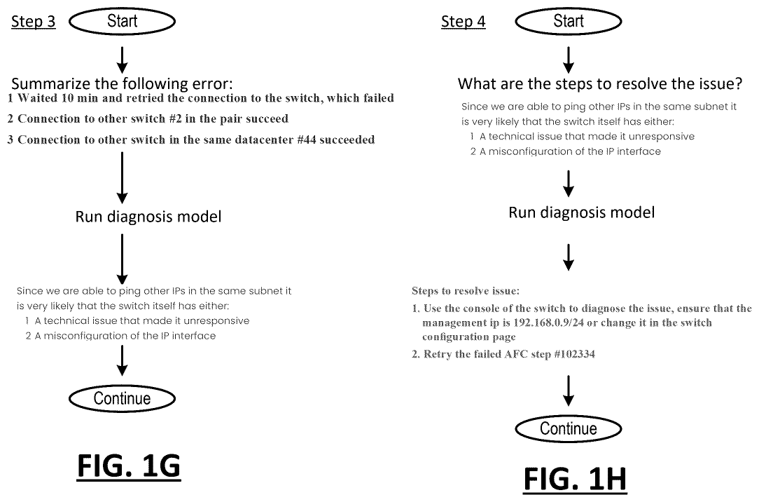

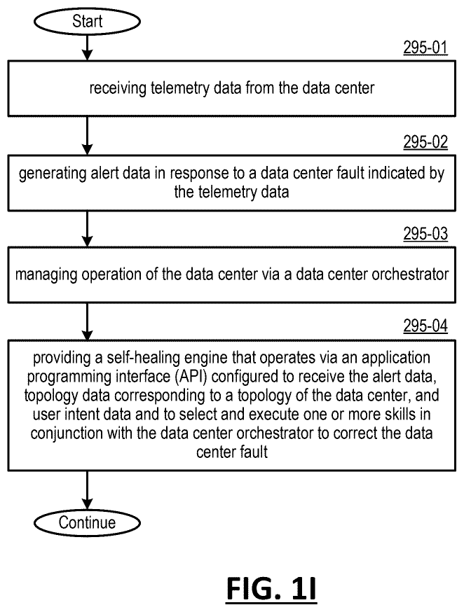

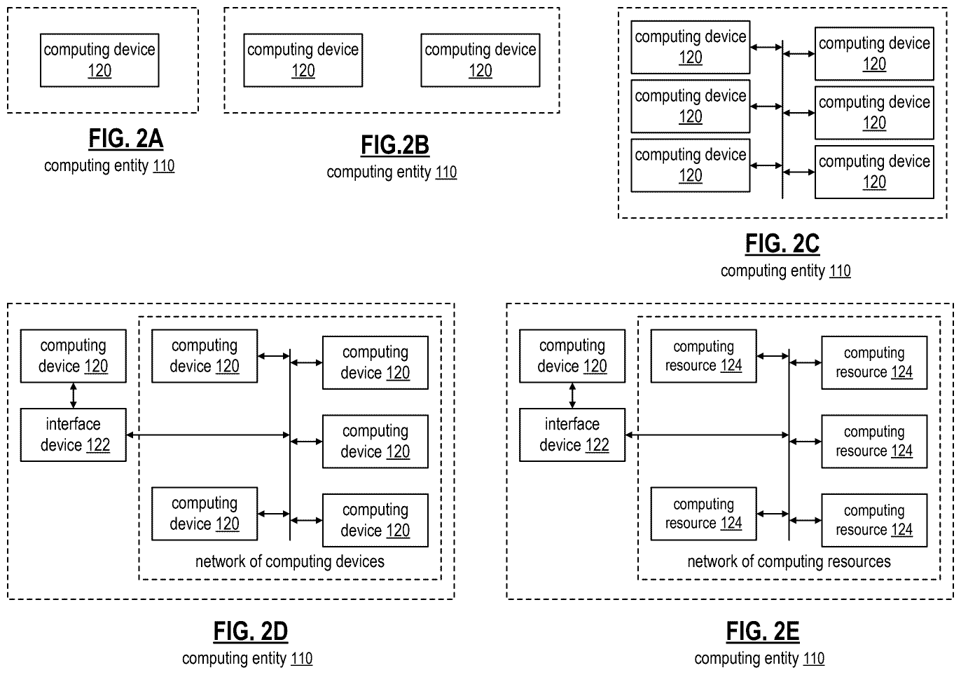

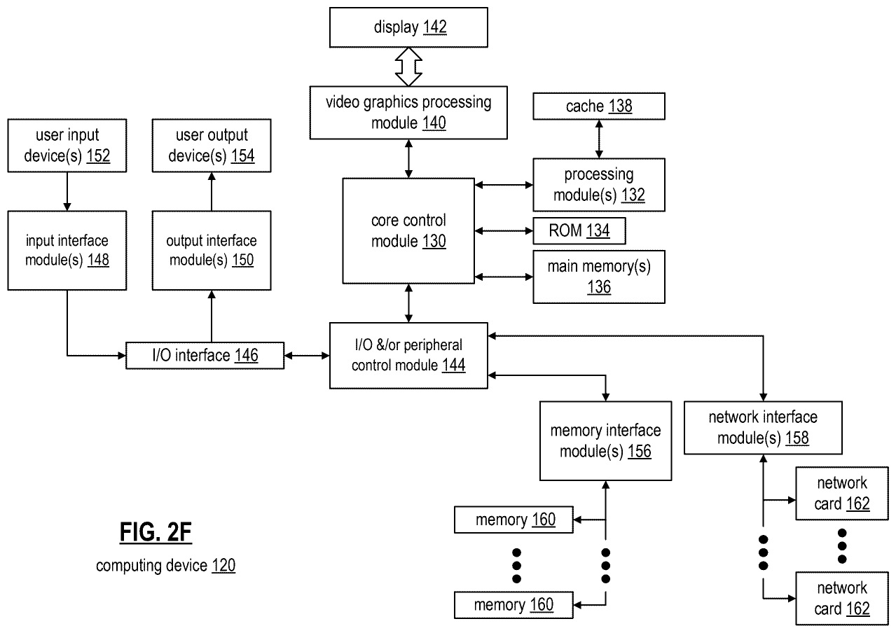

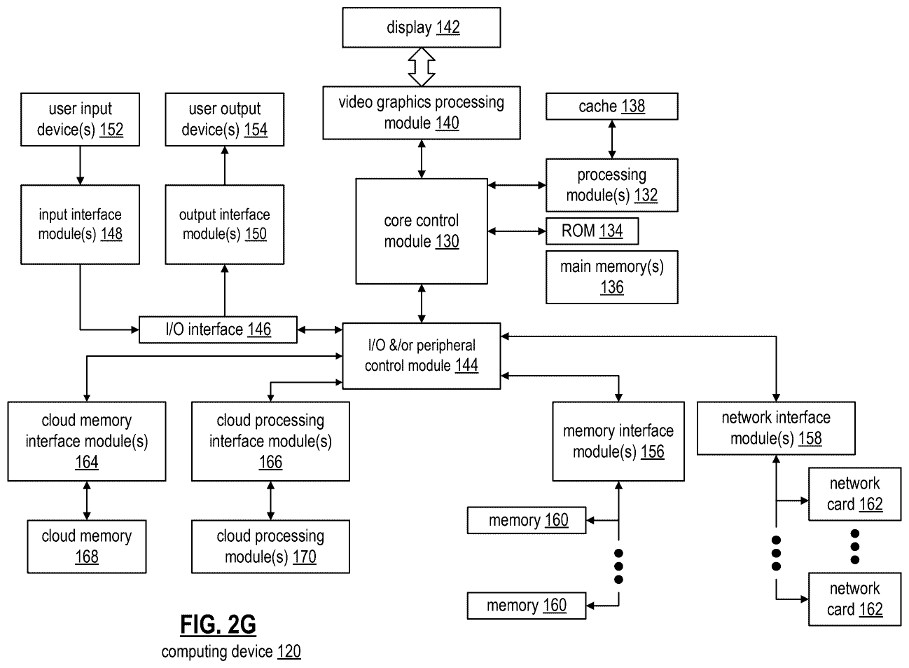

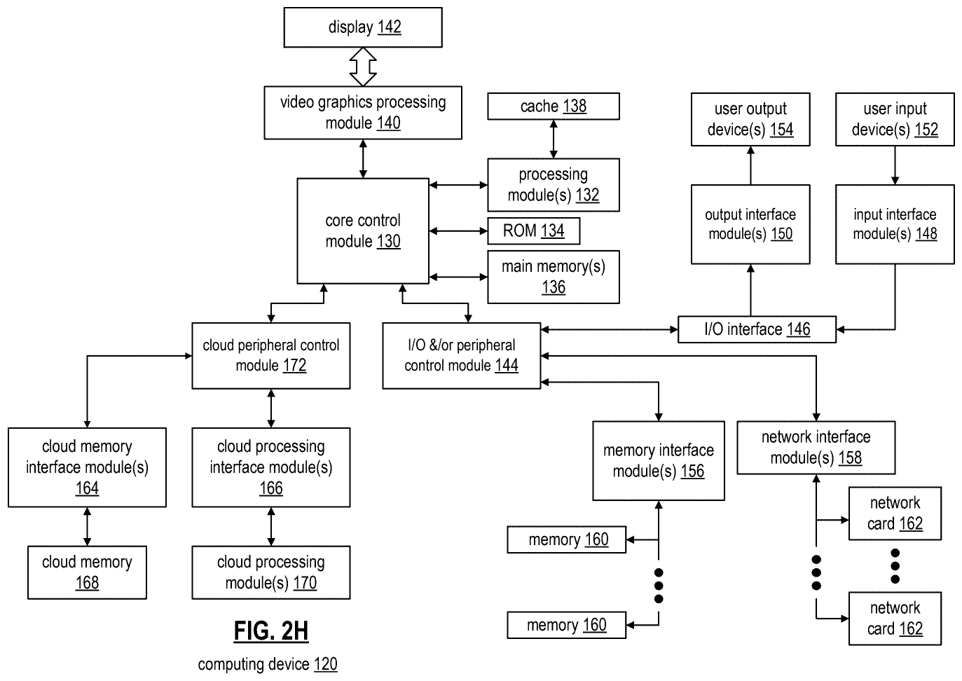

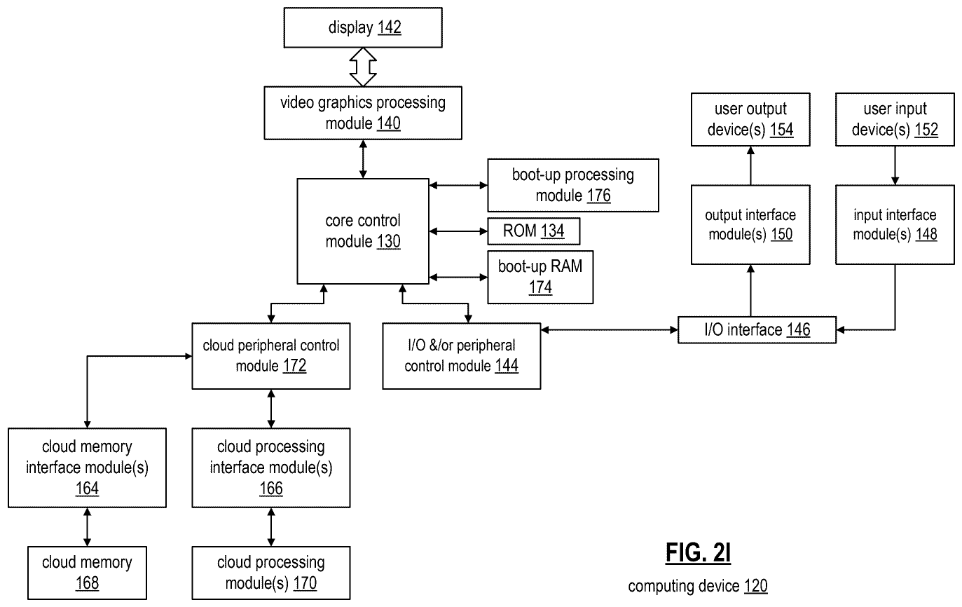

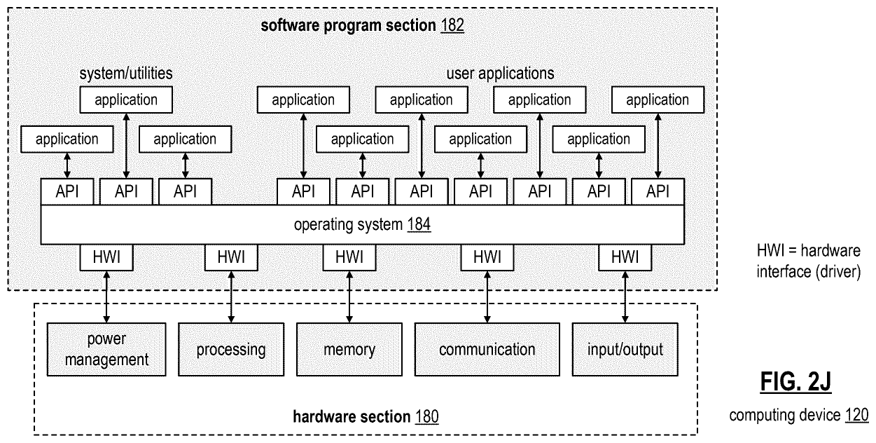

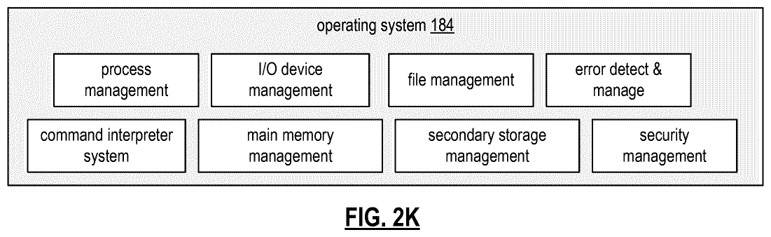

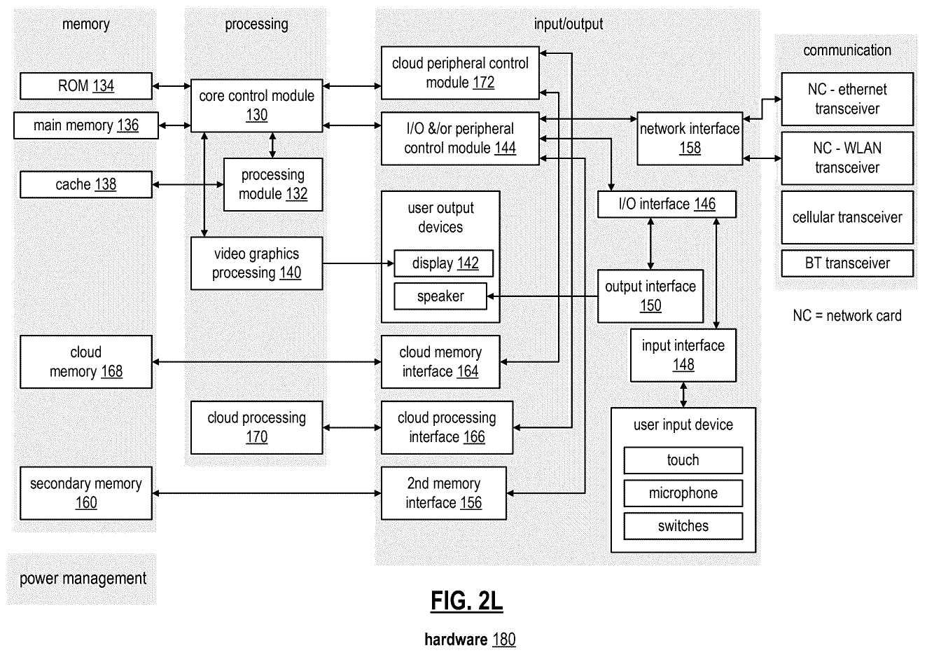

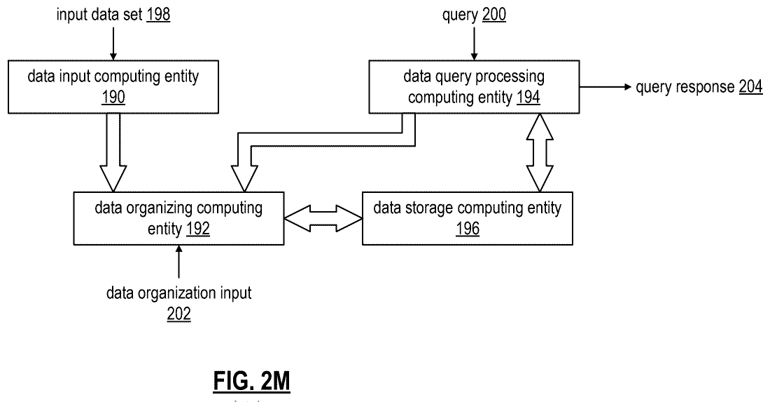

FIG. 1A presents a schematic block diagram representation of an example computer system. This system includes a monitoring system 10, self-healing engine 15 and data center orchestrator 20 that together operate in an automated fashion (e.g., based on user intent data and datacenter topology) to facilitate the detection, diagnosis and mitigation of faults (e.g., issues/problems) that occur in the data center 25. In various examples, the monitoring system 10, the self-healing engine 15 and the data center orchestrator 20 can be implemented via one or more processing modules and/or one or more computing elements 110 described later in conjunction with FIGS. 2A-2M that follow and/or include one or more additional elements that are not specifically shown. In particular examples, the self-healing engine can be implemented via a decentralized computer system that includes a plurality of geographically distinct computational nodes that communicate via a high-speed computer network and operate contemporaneously and in parallel to perform the various operations/functions described herein.

In various examples, the monitoring system 10 is configured to receive telemetry data from the data center 25 and to generate alert data in response to a data center fault (e.g., a problem, or other issue) indicated by the telemetry data. The data center orchestrator 20 is coupled to the monitoring system and is configured to manage operation of the data center 25. The self-healing engine 15 operates via an application programming interface (API) configured to receive the alert data, topology data corresponding to a topology of the data center 25, and user intent data and to select and execute one or more skills in conjunction with the data center orchestrator 20 to correct the data center fault.

In addition or in the alternative to any of the foregoing, the self-healing engine includes a cause prediction component that operates via a first large language model (LLM) trained on a first set of training data that includes previous data center faults (e.g., issues/errors) and corresponding general human-provided diagnostics expressed in natural language.

In addition or in the alternative to any of the foregoing, the self-healing engine further includes a solution prediction component that operates via a second LLM trained on a second set of training data that includes previous diagnostics and corresponding solutions expressed in natural language.

In addition or in the alternative to any of the foregoing, the self-healing engine further includes a skills-based automation engine that operates based on the one or more skills.

In addition or in the alternative to any of the foregoing, the skills-based automation engine operates based on the one or more skills using expert-defined instruction sets expressed in natural language.

In addition or in the alternative to any of the foregoing, the skills-based automation engine includes a third LLM trained to generate code based on the one or more skills and a code executor that executes the code to generate code results.

In addition or in the alternative to any of the foregoing, the skills-based automation engine includes a fourth LMM trained to interpret the code results and to generate results data in response thereto.

In addition or in the alternative to any of the foregoing, the user intent data indicates a goal and wherein the skills-based automation engine selects the one or more skills based on the goal.

In addition or in the alternative to any of the foregoing, the goal includes a plurality of sub-goals and wherein the skills-based automation engine operates recursively to achieve the plurality of sub-goals.

In addition or in the alternative to any of the foregoing, the one or more skills include one or more user-provided skills that are defined in natural language.

In addition or in the alternative to any of the foregoing, the data center 25 along with various components of the computer system can be implemented in conjunction with the hierarchical agents described in conjunction with U.S. Pat. No. 11,956,115 entitled, “Distributed control system for large scale geographically distributed data centers”, the contents of which are hereby incorporated by reference for any and all purposes.

In various examples, the self-healing engine utilizes three main components:
1. Effect-->cause prediction component that uses a fined tuned large language model that has been trained on previously seen errors and their general human-provided diagnostics, expressed in natural language.
2. Diagnostic->solution prediction component that uses a fined tuned large language model that has been trained on previously seen diagnostics and their solutions, expressed in natural language.
3. Skills-based automation engine. This engine uses expert-defined instructions sets expressed in natural language that are executed within a context.

In various examples, the self-healing engine facilitates a hardware orchestration solution that is “Intent-based”. In this context, the intent data indicating the user's intent is captured and used to drive the automated solution. This user intent can be defined in natural language and/or other abstract terms such as “server A needs to be connected to server B”. This intent can guide the diagnosis process as the self-healing engine can receive information about what is the intent of the user. Following the example above, the user's intent indicates which servers are meant to communicate and which are not, and as such, is able to distinguish between normal and abnormal behavior.

It should be noted that while the self-healing engine can benefit from continual learning, in various examples, the self-healing engine can be effective from the start. For example, the self-healing engine can start from the expert-provided skills and apply them much in the same way a human would read a repair manual. Over time, the self-healing engine can rely less on the skills and more on past-experience (in the form of a self-healing engine that can also be referred to as a “diagnostic-solution” prediction model, fine-tuned model, etc.) and will be able to generalize successful performance to address new issues.

Further examples of the operation of such a computer system, including various optional functions and features, are presented in the descriptions that follow.

FIG. 1B presents a flow diagram representation 30 of an example fault mitigation. In particular, a process is presented with a specific example that begins when an issue is detected by the monitoring system 10. The process proceeds to generate an initial diagnosis via an AI model (referred to in this instance as a “fine-tuned” model). In the in-depth diagnosis phase, diagnosis skills and/or an LLM are used by a skills engine to generate a detailed diagnosis.

In the final diagnosis phase, a further AI model is used to generate a suggested solution. In the fix candidate implementation phase, the skills engine again relies on diagnosis skills and/or other AI models to generate the code necessary to implement a fix. In the fix validation phase, the fix is tested. If successful, the diagnosis/fix combination are saved to an experience database for later use by the AI model. If unsuccessful, the process continues to iterate to generate further candidate fixes until a fix is finally validated. In various examples a time out or iteration limit could further be employed.

FIG. 1C presents a schematic block diagram representation of an example of a self-healing engine. In various examples, a final-objective (e.g., an end-goal) is expressed by the operator in natural language with queries such as “diagnose connectivity between server srv1 and srv2”. The application of the automated skills engine 35 can be recursive. The system then uses the self-healing engine to determine which combination of skills to use and in which order to achieve the desired result. Furthermore, the final objective may be achieved via a sequence/series of system generated intermediate objectives. Some skills can be built-in functions such as “run command on system” or “get topology” where others are “user provided” such as “get IP on server” or “check if two servers are from the same network”. Built-in skills can be executed if they match to a certain goal. Built-in skills can be implemented as code and provided by the automated skills engine 35.

In various examples, the code generation (e.g., the “code gen LLM”) component uses the skills definitions as a library of functions that the code can use to perform the goal (and/or sub-goals). The resulting code is executed by the code executor and the results are interpreted by the interpreter. The results could include outputs from equipment, data from external databases or other systems. The interpreter can restart the same process in a recursive fashion if skills have additional steps that define other sub-goals. The “memory” component allows the system to have steps that use information retrieved in other steps and/or prior procedures.

User-provided skills can be defined by the user in natural language by defining certain fields. An example of the definition of such a user-defined skill is presented in FIG. 1D. The code generation LLM can then generate, for each skill, a function definition such as ‘get_vlan_configured_on_switch (switch_port, switch): vlan. This definition can then be used by the code generation LLM and code executor to generate and execute the appropriate code to execute the skill if part of the code in an attempt to fulfill the objective.

Consider the following further examples.

### EXAMPLE #1

Scenario: Faulty switch
Trigger: Switch not responding on management interface
Symptom: Error text shows timeout
Root cause: Hardware Issue
Resolution: Forced switch reboot
Output/steps performed by the self-healing engine:
Step 1. Attempt connect to switch to verify state
Step 2. Send email to admin and tenants to notify of degraded state
Step 3. Send email to technician to reboot switch or replace switch
Step 4. Periodically check for update
Step 5. Send email to tenant notifying of remediation.

### EXAMPLE #2

Scenario: Faulty server component
Trigger: Event sent by server BMC
Symptom: Error text shows fault
Root cause: Hardware Issue
Resolution: Replace component
Output/steps performed by the self-healing engine:
Step 1. Send email to tenant notifying of degraded state
Step 2. Send email to technician to replace with spare.
Step 3. Periodically check for update of the situation
Step 4. Send email to tenant notifying of remediation

### EXAMPLE #3

Scenario: Optical links or cables don't provide proper connectivity
Trigger: Switch event sent via gNMI or syslog
Symptom: Error text shows fault
Root cause: Hardware Issue
Resolution: Replace cable or both transceivers and the fiber
Output/steps performed by the self-healing engine:
Step 1. Attempt connect to switch via ssh to verify state
Step 2. Notify to admin and tenants of degraded state
Step 3. Create ticket for technician to replace optics
Step 4. Periodically check for update
Step 5. Notify tenant notifying of remediation

### EXAMPLE #4

Scenario: Packet drop to on interface towards certain upstream providers
Trigger: GNMI trigger
Symptom: Packet loss in GNMI message
Root cause: 3rd party service failure
Resolution: Route through unaffected provider
Output/steps performed by the self-healing engine:
Step 1. Check the same destination via other providers
Step 2. Change routing rules on router to bypass provider
Step 3. Wait until uplink link is no longer experiencing issues (could be days)
Step 4. Return the routing to normal

### EXAMPLE #5

Scenario: Packet drop to on interface via spine
Trigger: GNMI trigger
Root cause: Misconfiguration or insufficient capacity issue
Resolution: Check for unbalanced traffic across links, check for congestion
Output/steps performed by the self-healing engine:
Step 1. Determine if other links could support the traffic
Step 2. Enable load-balancing on other links if not enabled.
Step 3. If nothing works notify admin of persistent congestion on links

FIGS. 1E-1H present flow diagram representations of example fault mitigation procedures. In the example shown, a sequence of four steps of a diagnosis process is presented that is implemented via a combination of fine-tuned and skills-based reasoning. Various results data are shown in color with Step 1 output shown in red, step 2 output shown in blue, step 3 output shown in green and step 4 output shown in purple.

Step 1 develops the initial diagnosis, based on the self-healing engine for an alert generated in response to a device timeout and responsive to a prompt to summarize the error. The results data indicates that a switch could not be reached during a particular provisioning step due to a time out while contacting a certain IP address.

Step 2 works up a more in-depth diagnosis. In this case, the user has prompted the system to find a matching skill or use the system to otherwise retrieve the steps of the skill to execute. The system could get diagnostic steps from the skills library. In other circumstances, the system could instead retrieve “remembered” diagnostic steps from the experience database, depending for example, on a confidence level which is proportional to the number of successful runs of the troubleshooting process. If one or the other fails to produce results the other will also be executed so the system will fall back to the human-defined skills-based engine if the “intuition” provided by the experience didn't help and also use the “intuition” if there is no set recipe for troubleshooting the respective issue. The self-healing engine can be used to generate and execute code to implement the steps of the determined skill. The results data indicates the steps of the skill that were performed. Step 3 works up a final diagnosis shown in green based on the results of Step 2. Step 4 generates a resolution suggestion shown in purple, again based on the self-healing engine.

FIG. 1I presents a flow diagram representation of an example of an example method. In particular, a method is presented for use with one or more of the functions and features described in conjunction with any of the other Figures presented herein. Step 295-01 includes receiving telemetry data from the data center. Step 295-02 includes generating alert data in response to a data center fault indicated by the telemetry data. Step 295-03 includes managing operation of the data center via a data center orchestrator. Step 295-04 includes providing a self-healing engine that operates via an application programming interface (API) configured to receive the alert data, topology data corresponding to a topology of the data center, and user intent data and to select and execute one or more skills in conjunction with the data center orchestrator to correct the data center fault.

In addition or in the alternative to any of the foregoing, the self-healing engine includes a cause prediction component that operates via a first large language model (LLM) trained on a first set of training data that includes previous data center faults and corresponding general human-provided diagnostics expressed in natural language.

In addition or in the alternative to any of the foregoing, the self-healing engine further includes a solution prediction component that operates via a second LLM trained on a second set of training data that includes previous diagnostics and corresponding solutions expressed in natural language.

In addition or in the alternative to any of the foregoing, the self-healing engine further includes a skills-based automation engine that operates based on the one or more skills.

In addition or in the alternative to any of the foregoing, the skills-based automation engine operates based on the one or more skills using expert-defined instruction sets expressed in natural language.

In addition or in the alternative to any of the foregoing, the skills-based automation engine includes a third LLM trained to generate code based on the one or more skills and a code executor that executes the code to generate code results.

In addition or in the alternative to any of the foregoing, the skills-based automation engine includes a fourth LMM trained to interpret the code results and to generate results data in response thereto.

In addition or in the alternative to any of the foregoing, the user intent data indicates a goal and wherein the skills-based automation engine selects the one or more skills based on the goal.

In addition or in the alternative to any of the foregoing, the goal includes a plurality of sub-goals and wherein the skills-based automation engine operates recursively to achieve the plurality of sub-goals.

In addition or in the alternative to any of the foregoing, the one or more skills include one or more user-provided skills that are defined in natural language.

FIG. 2A is schematic block diagram of an embodiment of a computing entity 110 that includes a computing device 120 (e.g., one or more of the embodiments of FIGS. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIGS. 2F-2L). The computing devices 120 perform the functions of a computing entity in a peer processing manner (e.g., coordinate together to perform the functions), in a master-slave manner (e.g., one computing device coordinates and the other supports it), and/or in another manner.

FIG. 2C is schematic block diagram of an embodiment of a computing entity 110 that includes a network of computing devices 120 (e.g., two or more from any combination of the embodiments of FIGS. 2F-2L). The computing devices are coupled together via one or more network connections (e.g., WAN, LAN, cellular data, WLAN, etc.) and perform the functions of the computing entity.

FIG. 2D is schematic block diagram of an embodiment of a computing entity 110 that includes a primary computing device (e.g., any one of the computing devices of FIGS. 2F-2L), an interface device (e.g., a network connection), and a network of computing devices 120 (e.g., one or more from any combination of the embodiments of FIGS. 2F-2L). The primary computing device utilizes the other computing devices as co-processors to execute one or more of the functions of the computing entity, as storage for data, for other data processing functions, and/or storage purposes.

FIG. 2E is schematic block diagram of an embodiment of a computing entity 110 that includes a primary computing device (e.g., any one of the computing devices of FIGS. 2F-2L), an interface device (e.g., a network connection) 122, and a network of computing resources 124 (e.g., two or more resources from any combination of the embodiments of FIGS. 2F-2L). The primary computing device utilizes the computing resources as co-processors to execute one or more of the functions of the computing entity, as storage for data, for other data processing functions, and/or storage purposes.

FIGS. 2F-2L are schematic block diagram of embodiments of computing devices that form at least a portion of a computing entity. FIG. 2F is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 2E include one more of the components shown in this Figure and/or in or more of FIGS. 2G through 2L.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieved from secondary memory 160 are the data and/or operational instructions requested by the processing module or can most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 2G is a schematic block diagram of an embodiment of a computing device 120 that includes a plurality of computing resources similar to the computing resources of FIG. 2F with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remote from the core control module and is accessed via a network.

FIG. 2H is a schematic block diagram of an embodiment of a computing device 120 that includes a plurality of computing resources similar to the computing resources of FIG. 2G with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 2I is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 2J is a schematic block diagram of another embodiment of a computing device 120 that includes a hardware section 180 and a software program section 182. The hardware section 180 includes the hardware functions of power management, processing, memory, communications, and input/output. FIG. 2L illustrates the hardware section 180 in greater detail. The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 2K.

FIG. 2K is a diagram of an example of the functions of the operating system of a computing device 120. In general, the operating system functions to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and.
control access to shared hardware components.

The I/O Device Management OS function coordinates translation of input data into programming language data and/or into machine language data used by the hardware components and translation of machine language data and/or programming language data into output data.

Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes:
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 190, a data organizing computing entity 192, a data query processing computing entity 194, and a data storage computing entity 196. Each of the computing entities is an implementation in accordance with one or more of the embodiments of FIGS. 2A through 2E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows correspond to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the

Figures. Such a memory device or memory element can be included in an article of manufacture. One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art can also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computer system for use with a data center comprising:
a monitoring system configured to receive telemetry data from the data center and to generate alert data in response to a data center fault indicated by the telemetry data;
a data center orchestrator coupled to the monitoring system that is configured to manage operation of the data center; and
a self-healing engine that operates via an application programming interface (API) configured to receive the alert data, topology data corresponding to a topology of the data center, and user intent data and to select and execute one or more skills in conjunction with the data center orchestrator to correct the data center fault.

2. The computer system of claim 1, wherein the self-healing engine includes a cause prediction component that operates via a first large language model (LLM) trained on a first set of training data that includes previous data center faults and corresponding general human-provided diagnostics expressed in natural language.

3. The computer system of claim 2, wherein the self-healing engine further includes a solution prediction component that operates via a second LLM trained on a second set of training data that includes previous diagnostics and corresponding solutions expressed in natural language.

4. The computer system of claim 3, wherein the self-healing engine further includes a skills-based automation engine that operates based on the one or more skills.

5. The computer system of claim 4, wherein the skills-based automation engine operates based on the one or more skills using expert-defined instruction sets expressed in natural language.

6. The computer system of claim 4, wherein the skills-based automation engine includes a third LLM trained to generate code based on the one or more skills and a code executor that executes the code to generate code results.

7. The computer system of claim 6, wherein the skills-based automation engine includes a fourth LMM trained to interpret the code results and to generate results data in response thereto.

8. The computer system of claim 4, wherein the user intent data indicates a goal and wherein the skills-based automation engine selects the one or more skills based on the goal.

9. The computer system of claim 8, wherein the goal includes a plurality of sub-goals and wherein the skills-based automation engine operates recursively to achieve the plurality of sub-goals.

10. The computer system of claim 1, wherein the one or more skills include one or more user-provided skills that are defined in natural language.

11. A method for use with a data center, the method comprising:
receiving telemetry data from the data center;
generating alert data in response to a data center fault indicated by the telemetry data;
managing operation of the data center via a data center orchestrator; and
providing a self-healing engine that operates via an application programming interface (API) configured to receive the alert data, topology data corresponding to a topology of the data center, and user intent data and to select and execute one or more skills in conjunction with the data center orchestrator to correct the data center fault.

12. The method of claim 11, wherein the self-healing engine includes a cause prediction component that operates via a first large language model (LLM) trained on a first set of training data that includes previous data center faults and corresponding general human-provided diagnostics expressed in natural language.

13. The method of claim 12, wherein the self-healing engine further includes a solution prediction component that operates via a second LLM trained on a second set of training data that includes previous diagnostics and corresponding solutions expressed in natural language.

14. The method of claim 13, wherein the self-healing engine further includes a skills-based automation engine that operates based on the one or more skills.

15. The method of claim 14, wherein the skills-based automation engine operates based on the one or more skills using expert-defined instruction sets expressed in natural language.

16. The method of claim 14, wherein the skills-based automation engine includes a third LLM trained to generate code based on the one or more skills and a code executor that executes the code to generate code results.

17. The method of claim 16, wherein the skills-based automation engine includes a fourth LMM trained to interpret the code results and to generate results data in response thereto.

18. The method of claim 14, wherein the user intent data indicates a goal and wherein the skills-based automation engine selects the one or more skills based on the goal.

19. The method of claim 18, wherein the goal includes a plurality of sub-goals and wherein the skills-based automation engine operates recursively to achieve the plurality of sub-goals.

20. The method of claim 11, wherein the one or more skills include one or more user-provided skills that are defined in natural language.
